(19) United States
(12) Patent Application Publication
(10) Pub. No.: US 2007/0113452 A1
(43) Pub. Date: May 24, 2007

(54) Note holder and method of making same

(76) Inventor: Ronald M. Pollack, Forest Hills, NY (US)

Correspondence Address: Galgano & Burke, Suite 35, 300 Rabro Drive, Hauppauge, NY, 11788, US

(21) Appl. No.: 11/285,971

(22) Filed: Nov. 23, 2005

(51) Int. Cl. G09F 3/20

(52) U.S. Cl. 40/658

(57) ABSTRACT

A holder for clamping a flexible sheet material and the like, includes an extruded plastic, elongated channel member having a base wall having two ends. The base wall is connected at one of the ends to a relatively short, upstanding forward leg having an inner face forming a bearing surface. The forward leg has a free upper end, and the base wall is connected at the other of the ends thereof to a relatively long, upstanding rearward leg having an upper end, and a top wall joined to the upper end of the rearward leg. The top wall is movable between its initial, extruded position, in which it extends down from the rearward leg to a position below and outside the free end of the forward leg, and an operational position, in which the top wall is moved to a position lying inside the forward leg so that it biasely and resiliently engages the bearing surface of the inner face of the forward leg. A method for making the holder is also disclosed.

### BACKGROUND OF THE INVENTION

1. Field of the Invention

This invention relates broadly to holders for removably holding sheet material such as a paper document. More particularly, this invention relates to an extruded plastic note holder which can be mounted on a surface such as the side of a computer monitor.

2. State of the Art

U.S. Pat. No. 2,530,821, issued to Hubbell in 1950, discloses a “Bulletin Sheet Holder and Support”. The holder/support consists of a generally U-shaped rigid member and a semi-rigid (rubber) “blade” which extends from one wall of the U-shaped member to the other wall. A piece of paper is inserted between the free end of the blade and the adjacent wall of the rigid member.

U.S. Pat. No. 4,105,127, issued to Höll in 1978, discloses a “Holder Bar for Sheet-like Articles”. The holder consists of a rectangular tube with a slot in one side wall. An inner omega-shaped clamp is disposed inside the tube with the open end of the clamp adjacent to the slot in the tube, A piece of paper inserted through the slot is engaged by the clamp,

Both of the above-described patents require the manual assembly of multiple components. U.S. Pat. No. 4,629,075, issued to Hutten in 1986, discloses a “Mounting Strip”. It consists of an elongated U-shaped, rigid plastic channel having a forward leg forming a bearing surface and a rearward leg forming a mounting surface. An elongated flexible gripper tongue is formed along the mounting surface of the channel and includes a clamping surface adapted to engage the bearing surface of the forward leg of the channel for receiving and clamping an article such as sheet material there between. The rigid plastic channel and flexible plastic gripper tongue are preferably co-extruded in a single operation to form a one-piece mounting strip having cooperating clamping elements with different durometer hardness. Hutten's mounting strip is more economical to manufacture compared to prior clamping devices described above because the channel and gripper tongue, having dual-durometer hardness, are integrally formed as a single co-extrusion. This eliminates the separate manufacturing operations required to fabricate the housing and clamping elements of prior art devices, as well as the additional step needed in such prior art devices to assemble the housing and clamping element.

While the Hutten device is clearly an improvement over the other two devices described above, it does have some disadvantages. The co-extrusion requires the use of two machines running at the same time extruding two different materials. Additionally, a rubber co-extrusion cannot exert much outward force on the bearing surface of the forward leg.

### SUMMARY OF THE INVENTION

It is therefore an object of the invention to provide a holder for clamping flexible sheet materials and the like.

It is another object of the invention to provide a holder for clamping flexible sheet materials and the like which is inexpensive to manufacture.

It is a further object of the invention to provide a holder for clamping flexible sheet materials and the like which is easy to manufacture.

It is also an object of the invention to provide a holder for clamping flexible sheet materials and the like which is made from a single component.

It is an additional object of the invention to provide a holder for clamping flexible sheet materials and the like which is made from a single component having a uniform single durometer.

It is still another object of the invention to provide a holder for clamping flexible sheet materials and the like which can be mounted to a surface in different ways.

Certain of the foregoing and related objects are readily attained according to the invention by the provision of a holder for clamping a flexible sheet material and the like, comprising an extruded plastic, elongated channel member preferably produced in a single extrusion of a single plastic material having a uniform durometer throughout, and having a base wall having two ends, said base wall being connected at one of said ends to a relatively short, upstanding forward leg having an inner face forming a bearing surface, said forward leg having a free upper end, and said base wall being connected at the other of said ends thereof to a relatively long, upstanding rearward leg having an upper end, and a top wall joined to said upper end of said rearward leg, and wherein said top wall is movable between its initial, extruded position, in which it extends down from said rearward leg to a position below and outside said free end of said forward leg, and an operational position, in which said top wall extends down from said rearward leg to a position lying inside said forward leg so that it biasely and resiliently engages the bearing surface of said inner face of said forward leg. The single extrusion of a single material is believed to result in a greater force being exerted by the tongue toward the forward leg.

Preferably, a double sided adhesive tape is attached on one side to one of said base wall and said rearward leg, and a release strip is detachably coupled to the other side of said double-sided adhesive tape. Alternatively, a mounting clip is joined to said rearward leg.

In a preferred embodiment, said top wall has a free end and is provided with a bent segment generally adjacent to its free end and said forward leg is provided with a bent segment generally adjacent its free end which is positioned to abut said bent segment of said top wall when said top wall is in its operational position.

In another preferred embodiment, said top wall has a generally dome-shaped profile. Advantageously, said free end of said forward leg has a beaded edge. This eliminates sharp edges and facilitates the insertion of a piece of paper between the tongue and the forward leg. Desirably, the holder also includes a pair of end caps having at least one stanchion extending normally therefrom and said rearward leg has an interior track detachably engageable by said stanchion. The end caps make the holder aesthetically more appealing. Most advantageously, said forward and rearward legs are non-orthogonal relative to said base wall. Most desirably, said top wall has a free end and is provided with a bowed segment generally adjacent its free end, and said forward leg is provided with an oppositely bowed segment generally adjacent its free end and wherein said bowed segments are disposed to resiliently engage one another in said operational position.

Certain of the foregoing and relating objects are also attained according to the invention by the provision of a method of making a holder for clamping flexible sheet materials and the like, said method comprising the steps of extruding synthetic resinous material to produce a holder made of a resilient plastic having a substantially uniform durometer in a single extrusion process, said extrusion step resulting in the formation of said holder in the form of an extruded plastic, elongated channel member comprising a base wall having two ends and a top wall joined to said upper end of said rearward leg, and wherein said top wall is movable between its initial extruded position, in which it extends down from said rearward leg to a position below and outside said free end of said forward leg, and an operational position, in which said top wall extends down from said rearward leg to a position lying inside said forward leg so that it biasely and resiliently engages the bearing surface of said inner face of said forward leg; and moving said top wall from said initial position to said operational position.

Preferably, the method further comprises the step of mounting said holder on a support. Desirably, the method further comprises the step of attaching one side of a double-sided adhesive tape to one of said base wall and said rearward leg, and applying a release strip to the other side of said double-sided adhesive tape.

In a preferred embodiment, the method comprises the steps of forming the top wall with a bent segment generally adjacent its free end, and forming the forward leg with an oppositely bent segment generally adjacent its free end. Advantageously, the method further comprises the steps of forming said top leg with a bowed section generally adjacent its free end and forming said forward leg with an oppositely bowed section adjacent its free end.

In a further embodiment, the method further comprises the step of forming said top wall with a domed-shaped profile. Advantageously, the method further comprises the step of forming said top forward and rearward walls so that they are non-orthogonal relative to said base wall. Desirably, the method further comprises the step of forming said free end of said forward leg with a beaded edge. Most advantageously, the method further comprises the step of detachably coupling end caps to ends of said channel member. Most desirably, the method further comprises the step of forming a mounting clip on said rearward leg.

Additional objects and advantages of the invention will become apparent to those skilled in the art upon reference to the detailed description taken in conjunction with the provided figures.

### BRIEF DESCRIPTION OF THE DRAWINGS

FIG. 1 is a side elevational view of the end of a first embodiment of a holder according to the invention as it is configured immediately after extrusion with its sloping top wall disposed outside of the upstanding sidewalls of the holder base wall;

FIGS. 1A-1E are views comparable to that of FIG. 1 but showing progressive transitional states of the holder at its sloping top wall is moved to a position between the upstanding side walls of the holder base wall with the aid of a tool;

FIG. 2 is a view similar to FIGS. 1 and 1A-1C but with the top wall in its operational position arranged between the upstanding legs of the base wall and biasely engaging the shorter upstanding leg and with an adhesive mounting pad attached to its base;

FIG. 3 is a view similar to FIG. 1 but showing an alternative position of the adhesive mounting pad;

FIG. 4 is a view similar to FIG. 2 but of a second embodiment having a dome-shaped top wall;

FIG. 5 is a front view of a computer monitor with a holder according to the invention attached to it and holding a piece of note paper;

FIG. 6 is a view similar to FIG. 1, showing a third and presently preferred embodiment in its pre-transitional, extruded state;

FIG. 7 is a view comparable to FIG. 6 and similar to FIG. 2 in that it shows the third embodiment in its operational position;

FIG. 8 is a perspective view of an end cap for use with the third embodiment;

FIG. 9 is a broken perspective view illustrating the installation of the end cap;

FIG. 10 is a broken perspective view illustrating how a piece of paper is inserted into the holder attached to the side of a computer monitor; and

FIGS. 11 and 12 are views comparable to that of FIGS. 6 and 7, respectively, but showing a fourth embodiment of the invention.

### DETAILED DESCRIPTION OF THE PREFERRED AND ILLUSTRATED EMBODIMENTS

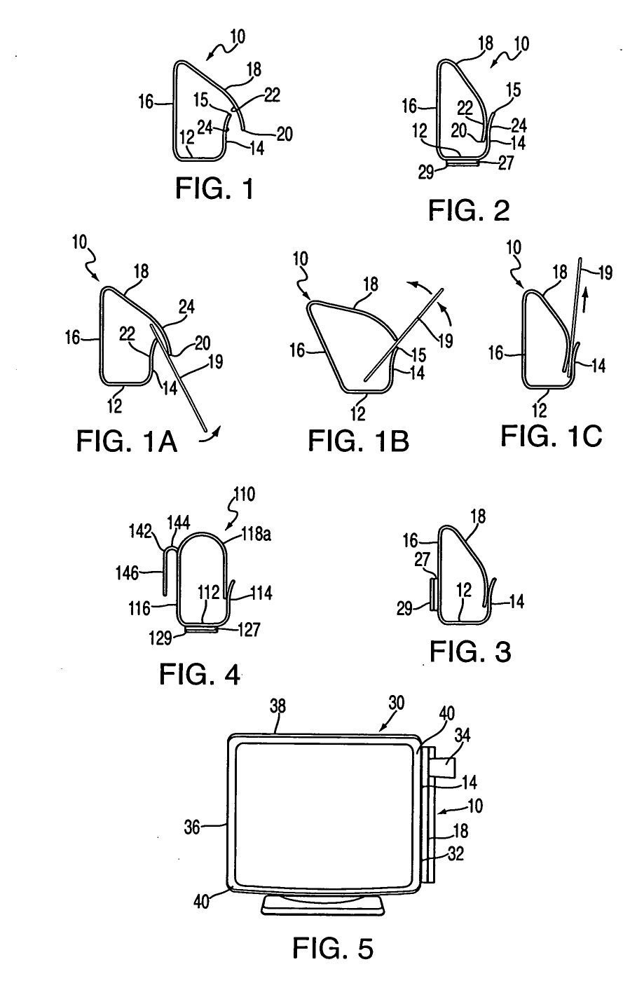

Turning now to FIG. 1, therein illustrated is a one-piece, resilient plastic note holder 10 embodying the present invention for clamping flexible sheet material such as note paper and the like. Note holder 10 has a generally horizontally extending base wall 12 connected at one end to a relatively short upstanding forward leg 14 having a free end 15 and at its opposite end to a relatively tall or long, upstanding rear leg 16, which together define a generally U-shaped channel therebetween. A sloping top wall 18 which serves as a resilient gripper tongue is joined at one end and extends downwardly from the upper end of the rearward leg 16 to a point beyond the free upper end 15 of the forward leg 14 so that they overlap.

According to the invention, the one-piece holder 10 is formed from a single extrusion of a single durometer, semi-rigid plastic material such as polyvinylchloride or polypropylene. The extrusion is preferably performed with the tongue 18 extending outside the channel as shown in FIG. 1. As shown in the transitional views FIGS. 1A-1C, after the extruded piece is cut to a desired length (or when the piece exits the extruder if they are extruded one at a time), and with the aid of a tool 19, the legs 14, 16 are bent apart from one another (FIG. 1A) by inserting one end of the tool 19 between the free ends 15 and 20 of sidewall 14 and top wall 18, respectively. Then the tool 19 is pivoted in the direction of the arrow so that tongue 18 is flexed upward and inward so its free end 20 passes over the free end 15 of forward leg 14 (FIG. 1B) and into the space between the two legs 14, 16 (FIG. 1C). The tool 19 is then removed, and the holder 10 assumes the “operational position” shown in FIG. 2. In this position, the free end 20 of the gripper tongue 18 lies between the forward and rearward legs 12, 16.

By extruding a semi-rigid plastic material in this manner, i.e., initially extruding the holder such that it is formed or extruded with its top wall or tongue 18 extending outside the channel defined in part by legs 14 and 16 (its initial “extruded position”) and re-positioning tongue 18 on the inner side of forward leg 14 (its “operational position”), the resilient tongue 18 is provided with a spring force or pretension which biasely urges it against the bearing or inner surface of leg 14. This technique eliminates the need for a more difficult and expensive co-extrusion.

Moreover, segment 22 of gripping tongue 20 adjacent its free end 20 preferably has an outwardly-extending curve or bow and, similarly, a segment 24 of forward leg 14 adjacent its free end is provided with a comparable inwardly-extending curve or bow which, in the operational position of FIG. 2, abut one another to define a clamping surface, and which together, cooperatively define a resilient “nip” between which a sheet-like note may be releasably and frictionally secured, as discussed below.

As seen in FIG. 2, a double-sided adhesive tape 27 is attached on one side to the base wall 12 of the holder 10 and its other side is covered with a removable release strip 29. As seen in FIG. 5, this allows the holder to be conveniently attached to a computer monitor 30 where the holder 10 is attached to the right side 32 thereof, and which is shown holding a note 34. It will be appreciated that the holder 10 could just as easily be attached, e.g., to the left, top or front sides 36, 38, 40, respectively, of monitor 30 or some other object as desired.

FIG. 3 shows the double-sided adhesive tape 27 and release strip 29 in an alternate placement on the rear leg 16 rather than the base wall 14.

Referring now to FIG. 4, a second embodiment 110 is similar to the first embodiment 10 shown in FIGS. 1-3 with similar reference numerals (increased by 100) referring to similar parts. Here it can be seen that the tongue 180 is in the form of a generally semicircular smooth curve extending approximately 180° from the rearward leg 116 over to the forward leg 114. It will also be noticed that in the embodiment 110, the tongue 180 is not bowed like the segment 22 of tongue 18 of the first embodiment.

Secondly, a generally L-shaped clip 142 is provided having a short leg 144 extending outwardly from the top end of rear leg 116 and a long leg 146 extending downwardly therefrom and substantially parallel to the rearward leg 116. Clip 142 can be used in conjunction with a J-shaped hanger (not shown) for mounting the holder on computer 30 or other item.

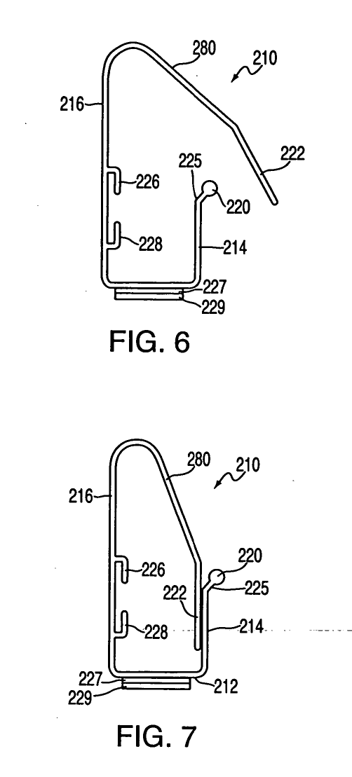

Turning now to FIGS. 6 and 7, the third and presently preferred embodiment is illustrated. The third embodiment 210 is similar to the first embodiment 10 with similar reference numerals (increased by 200) referring to similar parts. In this embodiment, the forward leg 214 has a beaded edge 220 which eliminates a potentially sharp exposed edge and facilitates the insertion of note paper. The leg 214 also has a bent or angled segment 225 slightly below the beaded edge 220 which facilitates the insertion of the paper sheet. The tongue 280 has a bent or angled segment 222 like the bent segment 22 in the tongue 18 of the first embodiment. When the tongue 280 is arranged to be operational as shown in FIG. 7, a majority of bent segment 222 resiliently abuts the inner surface of forward leg 214 with cooperates therewith to resiliently and frictionally grip a length of a sheet of paper (not shown) therebetween (as opposed to the relative “point” contact in the FIGS. 1-5 embodiment).

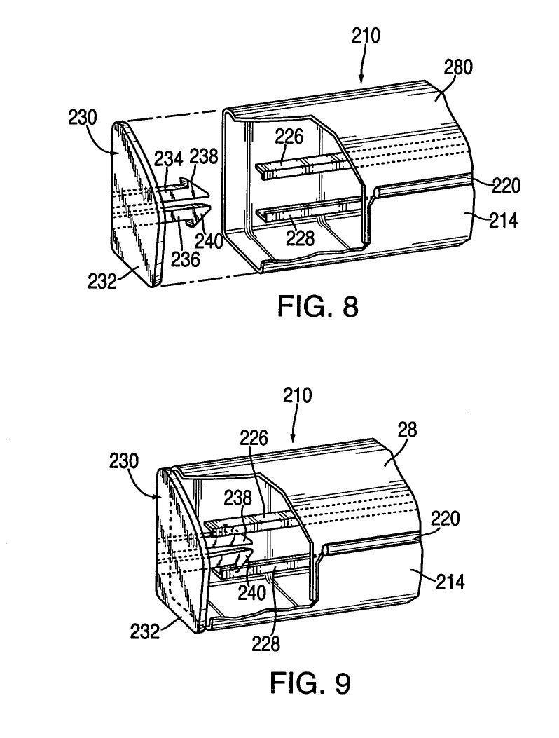

In addition, the holder 210 is provided with an interior track on the inner surface of the rearward leg 216. The track is composed to two spaced-apart, L-shaped members 226, 228 These L-shaped members are easily extruded along the entire length of the extruded piece 210. These L-shaped members 226, 228 are used to secure end caps 230 to the holder 210 as illustrated in FIGS. 8 and 9. End caps 230 each have planar portion 232 which is shaped to have the same profile as the holder 210. A pair of resilient stanchions 234, 236 extend orthogonally from the planar portion 332. As seen in FIG. 9, these stanchions 234, 236 each have a wedge-shaped barb 238, 240, respectively, at their end which engages one of the L-shaped track members 226, 228. The barbs 238, 240 are inserted into the channel defined by the track members 226, 228, and frictionally and biasily engage the track members 226, 228, thereby restraining or inhibiting the removal of the end cap 230. When so inserted, the barbed ends 238, 240 of the two stanchions 234, 236 are wedged together to provide a friction fit within the channel defined by the L-shaped track members 234, 236; the introduction of the stanchions 234, 236 into the channel is aided by the sloped side of the wedge shaped barbs 238, 240 which cam the barbed ends 238, 240 of the stanchions together as they are inserted into the channel. Those skilled in the art will appreciate that a second end cap (not shown) which is a mirror image of the end cap 230 shown is provided to cap the other end of the holder 210.

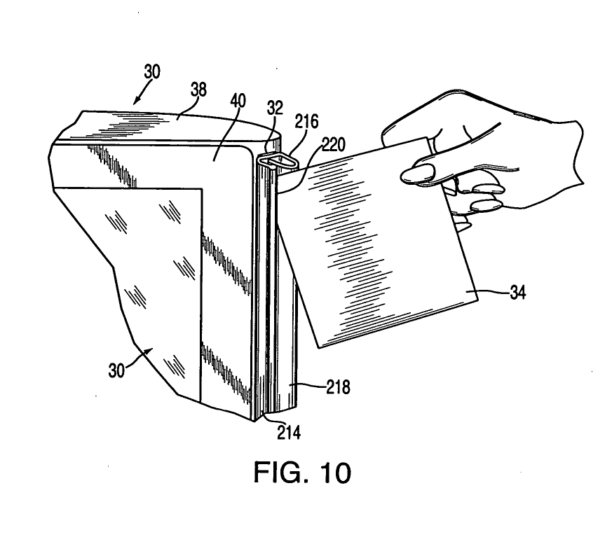

FIG. 10 shows the note holder 210 attached to the right side 32 of a computer monitor 30 with a sheet of paper 34 being easily inserted between the forward leg 214 and the tongue 218.

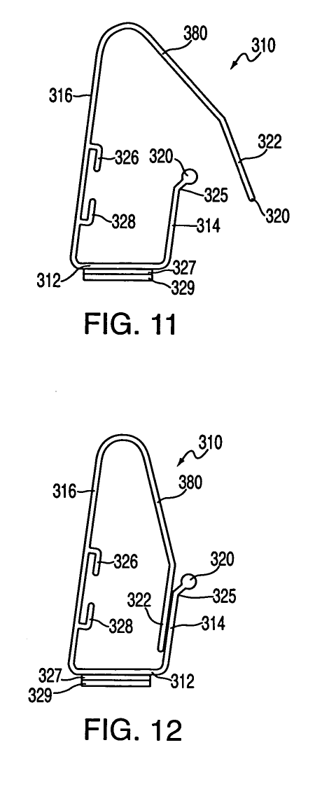

A further embodiment is illustrated in FIGS. 11 and 12 which are comparable to FIGS. 6 and 7 with similar reference numerals (increased by 100) referring to similar parts. Here, it can be seen that legs 314 and 316 are not orthogonal to the base 312. Rather, they are pitched forward (to the right in the drawing by about ten degrees. This makes it somewhat easier to insert a paper (not shown). It should also be noted that the tongue 380 is preferably dimensioned such that its end 320 does not touch the base 312 as can be seen in FIG. 12.

For a preferred application, the holder is approximately one inch by one half inch in overall dimensions. The thickness of the plastic is preferably from 0.030 to 0.035 inch and is preferably polyvinylchloride or a material with a similar durometer. The space between the track members 226, 228 is preferably about one third of an inch. The double sided tape is approximately three tenths of an inch thick. Of course, the various dimensions can be modified to suit a particular application.

There have been described and illustrated herein several embodiments of a note holder and a method of making the same. While particular embodiments of the invention have been described, it is not intended that the invention be limited thereto, as it is intended that the invention be as broad in scope as the art will allow and that the specification be read likewise. For example, the durometer rating, type of plastic and/or the relative dimensions of the legs and walls of the note holder can be modified to adjust the resiliency of the holder and, in turn, the force by which it frictionally holds a note or the like. It will therefore be appreciated by those skilled in the art that yet other modifications could be made to the provided invention without deviating from its spirit and scope as claimed.

What is claimed is:

1. A holder for clamping a flexible sheet material and the like, comprising:
an extruded plastic, elongated channel member produced in a single extrusion of a single plastic material having a uniform durometer throughout and having a base wall having two ends, said base wall being connected at one of said ends to a relatively short, upstanding forward leg having an inner face forming a bearing surface, said forward leg having a free upper end, and said base wall being connected at the other of said ends thereof to a relatively long, upstanding rearward leg having an upper end, and a top wall joined to said upper end of said rearward leg, and
wherein said top wall is movable between its initial, extruded position, in which extends down from said rearward leg to a position below and outside said free end of said forward leg, and an operational position, in which said top wall extends down from said rearward leg to a position lying inside said forward leg so that it biasely and resiliently engages the bearing surface of said inner face of said forward leg.

2. The holder according to claim 1, further comprising:
a double sided adhesive tape attached on one side to one of said base wall and said rearward leg; and
a release strip detachably coupled to another side of said double-sided adhesive tape.

3. The holder according to claim 1, further comprising:
a mounting clip joined to said rearward leg.

4. The holder according to claim 1, wherein:
said top wall has a free end and is provided with a bent segment generally adjacent to its free end.

5. The holder according to claim 4, wherein:
said forward leg is provided with a bent segment generally adjacent its free end which is positioned to abut said bent segment of said top wall when said top wall is in its operational position.

6. The holder according to claim 1, wherein:
said top wall has generally dome-shaped profile.

7. The holder according to claim 1, wherein:
said free end of said forward leg has a beaded edge.

8. The holder according to claim 1, additionally comprising:
a pair of end caps having at least one stanchion extending normally therefrom and wherein said rearward leg has an interior track detachably engageable by said stanchion.

9. The holder according to claim 1, wherein:
said forward and rearward legs are non-orthogonal relative to said base wall.

10. The holder according to claim 1, wherein:
said top wall has a free end and is provided with a bowed segment generally adjacent its free end, and
said forward leg is provided with an oppositely bowed segment generally adjacent its free end and wherein said bowed segments are disposed to resiliently engage one another in said operational position.

11. A method of making a holder for clamping flexible sheet materials and the like, said method comprising the steps:
extruding a synthetic resinous material to produce a holder made of a resilient plastic having a substantially uniform durometer in a single extrusion process, said extrusion step resulting in the formation of said holder in the form of an extruded plastic, elongated channel member comprising a base wall having two ends and a top wall joined to said upper end of said rearward leg, and
wherein said top wall is movable between its initial extruded position, in which it extends down from said rearward leg to a position below and outside said free end of said forward leg, and an operational position, in which said top wall extends down from said rearward leg to a position lying inside said forward leg so that it biasely and resiliently engages the bearing surface of said inner face of said forward leg; and
moving said top wall from said initial position to said operational position.

12. The method of claim 11, further comprising the step of:
mounting said holder on a support.

13. The method according to claim 1, further comprising the steps of:
attaching one side of a double-sided adhesive tape to one of said base wall and said rearward leg, and
applying a release strip to the other side of said double-sided adhesive tape.

14. The method according to claim 11, further comprises the steps of:
forming the top wall with a bent segment generally adjacent its free end; and
forming the forward leg with an oppositely bent segment generally adjacent its free end.

15. The method according to claim 11, further comprising the steps of:
forming said top leg with a bowed section generally adjacent its free end; and
forming said forward leg with an oppositely bowed section adjacent its free end.

16. The method according to claim 11, further comprising the step of:
forming said top wall with a domed-shaped profile.

17. The method according to claim 11, further comprising the step of:
forming said top forward and rearward walls so that they are non-orthogonal relative to said base wall.

18. The method according to claim 11, further comprising the step of:
forming said free end of said forward leg with a beaded edge.

19. The method according to claim 11, further comprising the step of:
detachably coupling end caps to ends of said channel member.

20. The method according to claim 11, further comprising the step of:
forming a mounting clip on said rearward leg.

21. A holder for clamping a flexible sheet material and the like, comprising:
an extruded plastic, elongated channel member having a base wall having two ends, said base wall being connected at one of said ends to a relatively short, upstanding forward leg having an inner face forming a bearing surface, said forward leg having a free upper end, and said base wall being connected at the other of said ends thereof to a relatively long, upstanding rearward leg having an upper end, and a top wall joined to said upper end of said rearward leg, and
wherein said top wall is movable between its initial, extruded position, in which extends down from said rearward leg to a position below and outside said free end of said forward leg, and an operational position, in which said top wall extends down from said rearward leg to a position lying inside said forward leg so that it biasely and resiliently engages the bearing surface of said inner face of said forward leg.
